(19) United States
(12) Patent Application Publication
(10) Pub. No.: US 2016/0297460 A1
(43) Pub. Date: Oct. 13, 2016

(54) Small Item Pouch

(71) Applicant: Jacqueline DeVault, Albuquerque, NM (US)

(72) Inventor: Jacqueline DeVault, Albuquerque, NM (US)

(21) Appl. No.: 14/683,741

(22) Filed: Apr. 10, 2015

(51) Int. Cl. B62B 3/14; B65D 33/16; B65D 33/01

(52) U.S. Cl. CPC B62B 3/1464; B65D 33/01; B65D 33/16

(57) ABSTRACT

A small item pouch to be attached to the shopping cart for carrying small and light-weight items easily while shopping is disclosed. In one embodiment, the present invention discloses a plastic made, reusable, enclosed small item pouch to be attached to the shopping cart with the help of Velcro wherein the Velcro attaches both the flaps from the center and Snaps fasteners provided at corners to firmly and securely attach the pouch. Further comprising of small drainage holes in pouch at the bottom to ease the drainage of occurring through spillage of any item stored in the pouch.

### CROSS REFERENCE TO RELATED APPLICATION

Applicable

### FEDERALLY SPONSORED RESEARCH AND DEVELOPMENT

Not Applicable

### MICROFICHE APPENDIX

Not Applicable

### BACKGROUND OF THE INVENTION

1. Field of the Invention

This invention pertains to the field of shopping plastic pouches and the like, and, more specifically, the invention pertains to a reusable plastic pouch that can be conveniently attached to a shopping cart. In addition to this, this invention relates to an enclosed, washable, see through plastic pouch that either folds closed, or hangs open from horizontal bars. This pouch contains two holes on the bottom, for drainage.

2. Background of the Invention

Nowadays, the typical shopper faces a number of problems associated with carrying and organizing small items and carrying and transporting these items, as they can fall out of the shopping cart. Various attempts have been made to address certain problems. Commonly, in a shopping cart, whether the basket is made from welded wires or is molded from polymeric material, the basket has a bottom wall that has multiple apertures through which small items can drop.

Many shoppers have numerous small items that must be carried, in addition to the small items they wish to purchase within the store. Many small items are lost during shopping due to inappropriate storage. Therefore, shoppers need to have a small pouch connected to the shopping cart, in order to safely secure and store the small items within this plastic pouch.

A need for a means for keeping small items in the shopping cart is thus keenly felt. There is a need for a device that stores all of the shoppers' small items and shopping accessories in one convenient plastic pouch, and hangs freely inside of the shopping cart in a position that is out of the way of the contents of the shopping cart, yet conveniently in reach to retrieve items instantly.

### SUMMARY OF THE INVENTION

There has been summarized above, rather broadly, the prior art that is related to the present invention in order that the context of the present invention may be better understood and appreciated. In this regard, it is instructive to also consider the objects and advantages of the present invention.

The small item pouch performs functions in multiple ways. The small item pouch can be adapted in many ways to increase its functionality and enhance the shopping experience. It may have such features as devices, flaps, pockets, straps, and wraps that are attached to the same to make shopping easier, safer and more efficient.

In one aspect, the small item pouch could also reduce over-packaging of goods, therefore making this pouch beneficial to the environment.

In one aspect, a shopping bag or small item pouch is described that addresses the problems and inconvenience of accumulating numerous small items efficiently on a single shopping trip; keep all of the items organized, and serve as reminder to check them out when finished shopping.

These, together with other objectives of the invention and along with the various features of novelty that characterize the invention, are pointed out with particularity in the claims annexed to and forming a part of this disclosure. For a better understanding of the invention, its advantages, and the specific purposes attained by its uses, reference should be made to the accompanying drawings and descriptive matter, in which a preferred embodiment of the invention is illustrated.

### BRIEF DESCRIPTION OF THE DRAWINGS

To further clarify various aspects of some example embodiments of the present invention, a more particular description of the invention will be rendered by reference to specific embodiments thereof, which are illustrated in the appended drawing. It is to be appreciated that the drawing depicts only illustrated embodiments of the invention, and are, therefore, not to be considered limiting of its scope. The invention will be described and explained with additional specificity and detail through the use of the accompanying drawing, in which:

FIG. 1 depicts a perspective view of the representative sample of the invention.

### DETAILED DESCRIPTION OF THE INVENTION

While this invention is susceptible to embodiment in many different forms, it is shown, in the drawings, and will herein be described in detail, as a preferred embodiment of the invention, with the understanding that the present disclosure is to be considered as an exemplification of the principles of the invention. This drawing and description is not intended to limit the broad aspect of the invention to the embodiment illustrated.

In its preferred embodiment, the present invention is a shopping container device that satisfies the modern requirements of a reusable shopping bag for small items being bought that remain unsatisfied by the prior art. The shopping bag of this invention is made of a clear plastic, and includes snaps or Velcro fasteners.

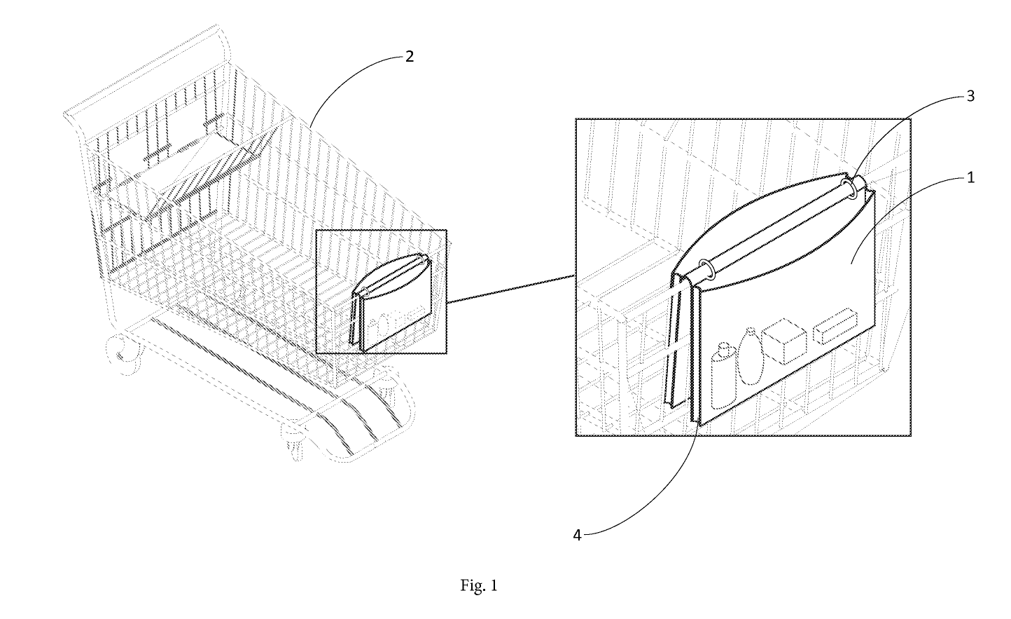

With reference to FIG. 1, the present invention discloses a small item pouch 1 to be attached to the shopping cart 2 wherein beneath the flap 3 of the pouch at the top; two heavy wire rings are provided, attached to basket posts near each end of pouch. Further, the invention includes a snap 4, uniquely attached to the small item pouch 1, to attach the bag to the interior of the shopping cart 2 during the shopping spree. This prevents other shoppers from lifting the bag completely out of the shopping cart and walking off with one's items.

Furthermore, the unit is an enclosed, plastic, washable, and see-through pouch that has a lid or other means of closing. This pouch has the ability to fold over itself to prevent spillage of the contents, wherein two holes are also provided in the bottom of the pouch for drainage. The pouch is able to open fully, and the top portion will wrap around a horizontal bar to hang open. Therefore, the contents are easily accessible. When closed, the pouch looks like an envelope from the front, and from the back is completely enclosed. When full, the pouch is a compact size. When empty, it will either lay flat or fold up for easy storage. It would not be harmed by pushing carts together. The unit further provides means for keeping items stored inside of the pouch, suitably fastened to the means for grasping the front of the pouch and pulling it open in order to grab the pouch contents with ease.

In yet another preferred embodiment, the present invention provides an enclosed, hang-able, folding pouch with the means to close completely, wherein said means for keeping the pouch contents inside when pouch is closed and allows pouch to hang when pouch is open and wrapped around a horizontal bar comprises a hook and loop closure on inner side of pointed flap. Furthermore, a plastic pouch with a method to close is provided, wherein said means for keeping the items stored inside of the pouch is an open top pouch front opening.

Also, the present invention provides a soft, washable, hang-able, reuse-able, convenient, eco-friendly, space-saving, pouch for keeping snacks within reach.

Although specific embodiments have been illustrated and described herein, it will be appreciated by those of ordinary skill in the art that any arrangement that is calculated to achieve the same purpose may be substituted for the specific embodiment shown. This application is intended to cover any adaptations or variations of the present invention. Therefore, it is manifestly intended that this invention be limited only by the claims and the equivalents thereof.

Although the invention has been explained in relation to its preferred embodiment, it is to be understood that many other possible modifications and variations can be made without departing from the spirit and scope of the invention.

We claim:

1. A small item pouch for shopping carts comprising:
(a) a first rectangular panel with foldable top edge;
(b) a second rectangular panel with foldable top edge and the second rectangular panel being secured to first panel at foldable edges and the panels having inner sides;
(c) inner sides forming a storage pouch;
(d) a detachable attachment device provided on the back sides of the foldable top edges to securely detachably attaching the said pouch with the shopping cart.

2. The small item pouch of claim 1, wherein said pouch is made of plastic material and Velcro snaps.

3. The small item pouch of claim 1, wherein two holes are provided in the bottom of said pouch for drainage.

4. The small item pouch of claim 1, wherein said pouch is foldable and can be snapped around the horizontal bar of the shopping cart to hang open.

5. The small item pouch of claim 1, wherein said pouch provides storage means.

6. The small item pouch of claim 1, wherein said pouch carrying small items suitably fastened for grasping the front of the pouch and pulling it open to grab the stored items.

7. The small item pouch of claim 1, wherein said pouch having closing means for keeping items inside said pouch.

8. The small item pouch of claim 1, wherein said pouch having closing means as the hook and the loop for keeping items inside said pouch.
